(19) United States
(12) Patent Application Publication
(10) Pub. No.: US 2012/0099432 A1
(43) Pub. Date: Apr. 26, 2012

(54) DECREASING JITTER IN PACKETIZED COMMUNICATION SYSTEMS

(75) Inventors: Dudu Bercovich, Kfar-Saba (IL); Oded Navi, Kiryat-Ono (IL)

(73) Assignee: Ceragon Networks Ltd., Tel-Aviv (IL)

(21) Appl. No.: 13/275,373

(22) Filed: Oct. 18, 2011

Related U.S. Application Data
(60) Provisional application No. 61/394,833, filed on Oct. 20, 2010.

(51) Int. Cl. H04L 12/26

(52) U.S. Cl. 370/235

(57) ABSTRACT

A method for decreasing jitter for at least some packets in a first packet-switched communication system including defining parameters for a communication channel wherein the parameters determine a maximum jitter level, setting up a communication channel using the parameters to provide a channel with a predefined maximum jitter level, selecting packets from the first packet-switched communication system which are to be transmitted via the defined-jitter communication channel, and transmitting the determined packets via the defined-jitter communication channel. A packet switched network operating a designated defined-jitter channel for packets requiring defined jitter. Related apparatus and methods are also described.

### RELATED APPLICATIONS

This application claims the benefit of priority under 35 USC 119(e) of U.S. Provisional Patent Application No. 61/394,833 filed Oct. 20, 2010, the contents of which are incorporated herein by reference in their entirety.

### FIELD AND BACKGROUND OF THE INVENTION

The present invention, in some embodiments thereof, relates to a method for decreasing jitter in packetized communication systems and, more particularly, but not exclusively, to a method for decreasing the effect of jitter in time-transfer protocols.

Packet switching is a network communications method which groups transmitted data, typically irrespective of content, type, or structure into suitably-sized blocks, called packets. The network over which packets are transmitted may be a shared network which routes each packet independently from all others and allocates transmission resources as needed. A principal goal of packet switching is to optimize utilization of available link capacity and to increase robustness of communication. When traversing network adapters, switches and other network nodes, packets are buffered and queued, resulting in variable delay and throughput, depending on the traffic load in the network.

Jitter is the variation in network transfer time between packets, and may be due to various causes, including network congestion and network timing drift.

Network resources are sometimes managed by statistical multiplexing or dynamic bandwidth allocation, in which a physical communication channel is effectively divided into an arbitrary number of logical variable-bit-rate channels or data streams. Each logical stream consists of a sequence of packets, which are normally forwarded by a network node asynchronously, using first-in, first-out buffering. Alternatively, the packets may be forwarded according to some scheduling discipline for fair queuing or for differentiated or guaranteed quality of service, such as pipeline forwarding or time-driven priority (TDP). Any buffering introduces varying latency and throughput in transmission. In case of a shared physical medium, the packets may be delivered according to some packet-mode multiple access scheme.

Packet switching contrasts with another principal networking paradigm, circuit switching, a method which sets up a specific circuit with a limited number of dedicated connections of constant bit rate and constant delay between nodes for exclusive use during the communication session.

In telecommunications, a circuit switching network is one that establishes a circuit (or channel) between nodes and terminals before the users may communicate, as if the nodes were physically connected with an electrical circuit.

In circuit switching, a bit delay is constant during a connection, as opposed to packet switching, where packet queues may cause varying packet transfer delay. A given circuit cannot be used by other callers until the circuit is released and a new connection is set up. Even if no actual communication is taking place in a dedicated circuit, the dedicated circuit remains unavailable to other users. Channels which are available for new calls to be set up are said to be idle.

Virtual circuit switching is a packet switching technology that may emulate circuit switching, in the sense that bandwidth is reserved on the packet switched system to establish a connection over a specific route before any packets are transferred, and that packets are delivered in order. References herein to circuit switching are intended to include such circuit switching emulation.

Several time-transfer protocols are presently defined with reference to networks.

A protocol known as the Precision Time Protocol (PTP) is a time-transfer protocol defined in the IEEE 1588-2002 standard, which allows synchronization of networks such as, for example, Ethernet. Accuracy within the sub-microsecond range can be achieved with this protocol when using hardware generated timestamps.

IEEE 1588 is designed to fill a niche not well served by either of two dominant protocols, Network Time Protocol (NTP) and Global Positioning System (GPS) IEEE 1588 is designed for local systems requiring very high accuracies beyond those attainable using NTP. It is also designed for applications that cannot bear the cost of a GPS receiver at each node, or for which GPS signals are inaccessible

The IEEE 1588 Precision Time Protocol (PTP) provides a standard method to synchronize devices on a network with sub-microsecond precision. The protocol synchronizes slave clocks to a master clock, ensuring that events and timestamps in all devices use the same time base. IEEE 1588 is optimized for user-administered, distributed systems; minimal use of network bandwidth; and low processing overhead.

By synchronizing multiple clocks over networks such as Ethernet, IEEE 1588 provides sub-microsecond synchronization over long distances with standard cabling. There are two steps for synchronizing devices using IEEE 1588: (1) determine which device serves as the master clock, and (2) measure and correct time skew caused by clock offsets and network delays. When a system is initialized, the IEEE 1588 protocol uses a Best Master Clock algorithm to determine which clock in the network is the most precise. That clock becomes the master clock. Other clocks become slaves and synchronize their clocks with the master.

Because a time difference between the master clock and slave clock is a combination of the clock offset and message transmission delay, correcting the clock skew is done in two phases—offset correction and delay correction. The master clock initiates offset correction using “sync” and “follow-up” messages. When the master sends a sync message, the slave uses its local clock to timestamp the arrival of the sync message and compares it to the actual sync transmission timestamp in the master clock's follow-up message. The difference between the two timestamps represents the offset of the slave plus the message transmission delay. The slave clock then adjusts the local clock by this difference. To correct for the message transmission delay, the slave uses a second set of sync and follow-up messages with its corrected clock to calculate the master-to-slave delay. The second set of messages is necessary to account for variations in network delays. The slave timestamps the sending of a delay request message. The master clock timestamps the arrival of the delay request message. It then sends a delay response message with the delay request arrival timestamp. The difference between the timestamps is the slave-to-master delay. The slave averages the two directional delays and then adjusts its clock by the delay to synchronize the two clocks. Because the master and slave clocks drift independently, periodically repeating offset correction and delay correction keeps the clocks synchronized.

The IEEE 1588 PTP recognizes the existence of jitter, and provides an arithmetical method to decrease the adverse effect of jitter on synchronization across networks.

Many IEEE 1588 implementations may have sub-microsecond skew, but actual performance is highly implementation-specific. One of the implementation dependencies is network topology. The simplest network topology—two devices on a single cable—provides less network jitter than a network topology with many devices linked using routers and switches. If more than one subnet is required, to increase distance or number of devices, then a network switch with an accurate IEEE 1588 clock, called a boundary clock, becomes the master clock and synchronizes the devices on the subnets. Also, wide variations in network traffic may negatively impact clock skew as the delay correction lags current traffic conditions. Because many factors can degrade skew performance, benchmarking and monitoring actual skew performance over time is recommended.

### SUMMARY OF THE INVENTION

Various types of networks are often implemented nowadays over packet network protocols, because packet networks are ubiquitous. We therefore sometimes find applications which are more suitable for non-packet, or circuit switching, networks, which are being implemented over packet networks.

Packet networks typically implement the transfer of packets of data through the network one after another, without interleaving data of one packet with another. Simply put, a packet of data which is to be transmitted by a packet network node has to wait in line behind other packets. There exist Quality of Service (QoS) protocols, which use several queues to differentiate between higher priority packets and lower priority packets. In packet networks implementing QoS, a first high priority packet will not necessarily need to wait behind a second packet, unless: (a) the second packet is of a higher priority; (b) the second packet is of a same priority and arrived earlier than the first packet; (c) the second packet is already partly transmitted, and therefore its transmission will not be interrupted to allow the first packet through.

When a first packet is sent through a packet network, such as, for example, an IP network, the first packet sometimes has to wait for a second, large, packet to go through the network before the first network may pass. A receiver receiving the first packet will see jitter, that is a variation in message transmission delay, depending on whether the first packet had to wait behind the second, large, packet, or not.

Requesting a high Quality of Service (QoS) for the first packet will not solve the problem of the first packet stuck behind the second, large, packet. QoS defines queues with different priorities, yet once the first packet enters the high QoS queue, it has to wait its own turn, possibly behind the second, large packet which entered before it into the high QoS queue. It is noted that applications such as Voice-over-IP (VoIP) may include large packets and also demand high QoS. Even if the high QoS guarantees that the first packet passes through the high QoS communication channel with less than some specific message delay time, the existence of the second, large packet will cause jitter, which is caused by variability in the message delay.

The present invention, in some embodiments thereof, opens a dedicated communication channel for some packets, in order to provide a defined jitter communication channel for the packets.

According to an aspect of some embodiments of the present invention there is provided a method for decreasing jitter for at least some packets in a first packet-switched communication system including defining parameters for a communication channel wherein the parameters determine a maximum jitter level, setting up a communication channel using the parameters to provide a channel with a predefined maximum jitter level, selecting packets from the first packet-switched communication system which are to be transmitted via the defined-jitter communication channel, and transmitting the determined packets via the defined-jitter communication channel.

According to some embodiments of the invention, the parameters include at least one member of the group including a bandwidth, a maximum packet size and a transmission rate.

According to some embodiments of the invention, a specific bandwidth is defined for the defined-jitter channel, based, at least in part, on a size of the determined packets and a required rate of transmission of the determined packets.

According to some embodiments of the invention, a specific packet size limit is defined for the defined-jitter channel, based, at least in part, on a required rate of transmission of the determined packets and on bandwidth allotted to the defined jitter communication channel.

According to some embodiments of the invention, a limit on a rate of transmission of the determine packets is set, based, at least in part, on a size of the determined packets and on bandwidth allocated to the defined-jitter communication channel.

According to some embodiments of the invention, the determining includes selecting packets under a certain size.

According to some embodiments of the invention, the determining includes selecting synchronization packets. According to some embodiments of the invention, the determining includes selecting packets operational according to the IEEE 1588 time-transfer protocol.

According to some embodiments of the invention, the defined jitter communication channel is implemented over the first packet-switched communication system. According to some embodiments of the invention, the defined jitter communication channel is implemented over a second communication system.

According to some embodiments of the invention, further including packaging the packets of the packet-switched communication channel in frames, and packaging the determined packets in a dedicated portion of at least some of the frames.

According to some embodiments of the invention, the packet-switched communication channel includes a fixed delay communication channel.

According to an aspect of some embodiments of the present invention there is provided a transmitter using the methods described herein. According to an aspect of some embodiments of the present invention there is provided a receiver using the methods described herein.

According to an aspect of some embodiments of the present invention there is provided a communication system using the methods described herein. According to an aspect of some embodiments of the present invention there is provided a computer-readable storage medium containing a set of instructions for implementing the methods described herein.

According to an aspect of some embodiments of the present invention there is provided a packet switched network operating a designated defined-jitter channel for packets requiring defined jitter.

According to some embodiments of the invention, the defined-jitter channel includes a specified bandwidth, based, at least in part, on a size of the packets requiring defined jitter and on a rate of transmission of the packets requiring defined jitter.

According to some embodiments of the invention, the packets requiring defined jitter include synchronization packets. According to some embodiments of the invention, the packets requiring defined jitter include packets according to the IEEE 1588 time-transfer protocol.

According to some embodiments of the invention, the defined-jitter channel includes a fixed delay channel.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

Implementation of the method and/or system of embodiments can involve performing or completing selected tasks manually, automatically, or a combination thereof. Moreover, according to actual instrumentation and equipment of embodiments of the method and/or system, several selected tasks could be implemented by hardware, by software or by firmware or by a combination thereof using an operating system.

For example, hardware for performing selected tasks according to embodiments could be implemented as a chip or a circuit. As software, selected tasks according to embodiments could be implemented as a plurality of software instructions being executed by a computer using any suitable operating system. In an exemplary embodiment, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1A is a simplified illustration of a prior art multi-channel communication system;

FIG. 1B is a simplified illustration of a first instance of packets queuing in one channel of the communication system of FIG. 1A;

FIG. 1C is a simplified illustration of a second instance of packets queuing in one channel of the communication system of FIG. 1A;

FIG. 1D is a simplified illustration of a third instance of packets queuing in one channel of the communication system of FIG. 1A;

FIG. 2A is a simplified illustration of a multi-channel communication system constructed and operating according to an embodiment;

FIG. 2B is a simplified illustration of an alternative embodiment of the system of FIG. 2A;

FIG. 3 is a simplified illustration of an alternative embodiment of the system of FIG. 2A;

FIG. 4 is a simplified flowchart illustration of an embodiment;

FIG. 5A is a simplified illustration of an embodiment of the system of FIG. 2A which includes more than two nodes;

FIG. 5B is a simplified illustration of an alternative embodiment of the system of FIG. 2A which includes more than two nodes;

FIG. 5C is a simplified illustration of another alternative embodiment of the system of FIG. 2A which includes more than two nodes;

FIG. 6 is a simplified flowchart illustration of an example embodiment applied to a time transfer protocol;

FIG. 7A is a histogram of Packet Delay Variation (PDV) of two simulations, made with and without using an example embodiment; and

FIG. 7B is a graph of a Maximum Time Interval Error (MTIE) for two simulations similar to the simulations of FIG. 7A, compared to several communication quality limits.

### DESCRIPTION OF SPECIFIC EMBODIMENTS

The present invention, in some embodiments thereof, relates to a method for decreasing jitter in packetized communication systems and, more particularly, but not exclusively, to a method for decreasing the effect of jitter in time-transfer protocols.

Various types of communication systems are often implemented nowadays over packet network protocols, because packet networks are ubiquitous. We therefore sometimes find applications which are more suitable for circuit switching communication systems which are being implemented over packet networks.

A packet network typically implements transfer of packets through the network one after another, without interleaving data of one packet with another. Simply put, a packet which is to be transmitted by a packet network node has to wait in line behind other packets.

There exist Quality of Service (QoS) protocols, which use several queues to differentiate between higher priority packets and lower priority packets. In packet networks implementing QoS, a first, high priority packet will not necessarily need to wait behind a second packet, unless: (a) the second packet is of a higher priority; (b) the second packet is of a same priority and arrived earlier than the first packet; (c) the second packet is already partly transmitted, and therefore its transmission will not be interrupted to allow the first packet through.

When a first group of packets, or a first type of packet, is sent through a packet network, such as, for example, time transfer packets through an IP network, some packets of the first type may have to wait for other, possibly large, packets to go through the network before some of the packets of the first packet may pass. A receiver receiving the packet of the first type will see jitter, that is a variation in message transmission delay, depending on whether some of the first packets had to wait behind other packets or not.

Requesting a high Quality of Service (QoS) for the first packet type will not solve the problem of the packet of the first type stuck behind the other packets. QoS defines queues with different priorities, yet once a first packet enters the high QoS queue, it has to wait its own turn, possibly behind a second, large packet which entered before it into the high QoS queue. It is noted that applications such a Voice-over-IP (VoIP) may include large packets and also demand high QoS.

Even if the high QoS guarantees that packets of the first type pass through the high QoS communication channel with less than some specific message delay time, the existence of the second, large packet will cause jitter.

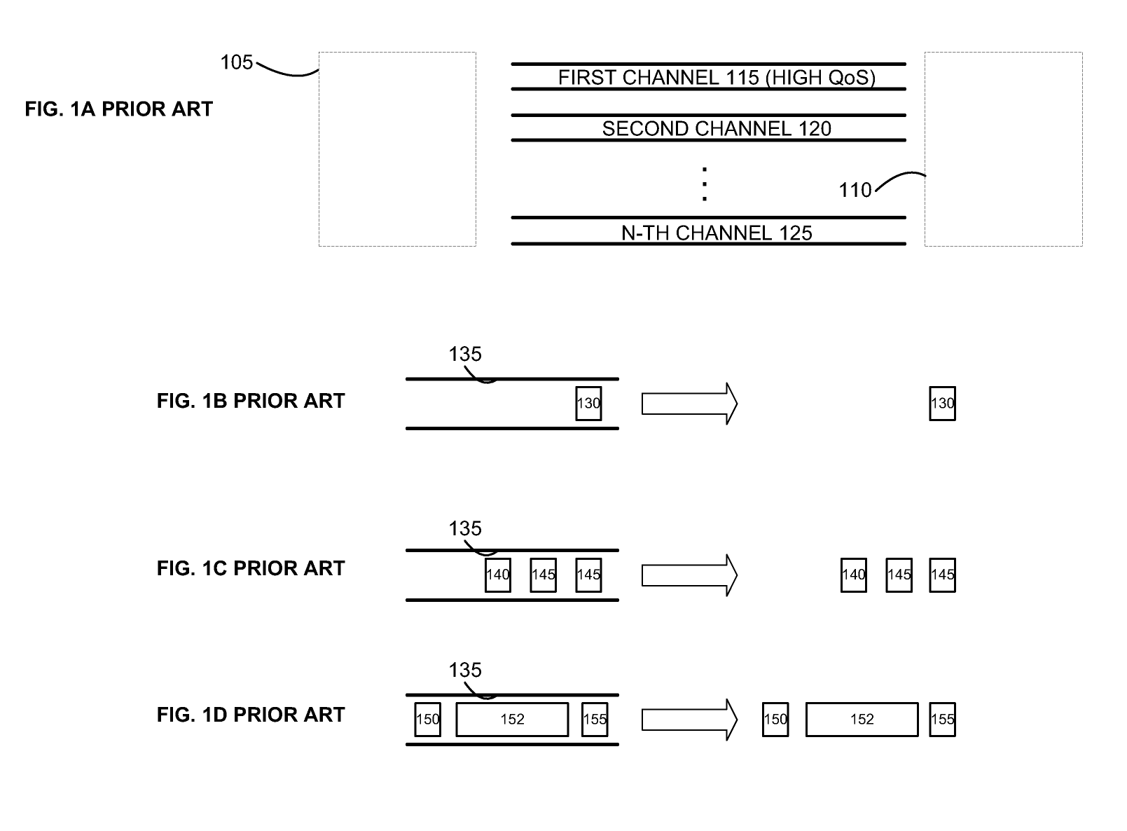

Reference is now made to FIG. 1A, which is a simplified illustration of a prior art multi-channel communication system.

FIG. 1A depicts a first node 105 having several communication channels to a second node 110. A first communication channel 115, by way of a non-limiting example, is a high QoS communication channel. Other communication channels, by way of a non-limiting example a second communication channel 120 and additional communication channels up to an N-th communication channel 125, may or may not be guaranteed QoS communication channels.

Reference is now additionally made to FIG. 1B, which is a simplified illustration of a first instance of packets queuing in one channel of the communication system of FIG. 1A.

FIG. 1B depicts a first packet 130, of a type which should preferably arrive with minimal jitter, queuing in an input queue 135 in one channel, for example the first communication channel 115 of the communication system of FIG. 1A. In FIG. 1B the first packet 130 is first and only in the input queue 135, and, assuming that the queue 135 corresponds to a high QoS communication channel, the first packet 130 arrives at the second node after some message transmission delay, comprising some queuing time plus transmission time.

Reference is now additionally made to FIG. 1C, which is a simplified illustration of a second instance of packets queuing in one channel of the communication system of FIG. 1A.

FIG. 1C depicts the same input queue 135, in which a first packet 140, of a type which should arrive with minimal jitter, is queuing after two other packets 145. In

FIG. 1C the first packet 140 is not any more the first and only in the input queue 135, and even assuming that the queue 135 corresponds to a high QoS communication channel, the first packet 140 arrives at the second node after a longer queuing time, plus the transmission time.

Reference is now additionally made to FIG. 1D, which is a simplified illustration of a third instance of packets queuing in one channel of the communication system of FIG. 1A.

FIG. 1D depicts the same input queue 135, in which a first packet 150, of a type which should arrive with minimal jitter, is queuing after a large packet 152, and another packet 155. In FIG. 1D the first packet 150 is behind the large packet 152, and even assuming that the queue 135 corresponds to a high QoS communication channel, the first packet 150 arrives at the second node after a longer queuing time, plus the transmission time.

Simply giving packets which should arrive with low jitter a highest QoS than all other packets may not be a good enough solution. For one, what if there are two or more such types or groups of low-jitter-requiring packets? Which type gets the highest QoS? If the types share the highest QoS, what happens to their jitter? How do arrival times of one type at the highest QoS input queue interact with arrival times of another type at the queue?

Some embodiments open a dedicated communication channel for some packets, in order to provide a dedicated defined-jitter communication channel for the packets.

It is noted that the defined-jitter communication channel is often a low-jitter and/or minimal-jitter, and/or even a zero jitter communication channel.

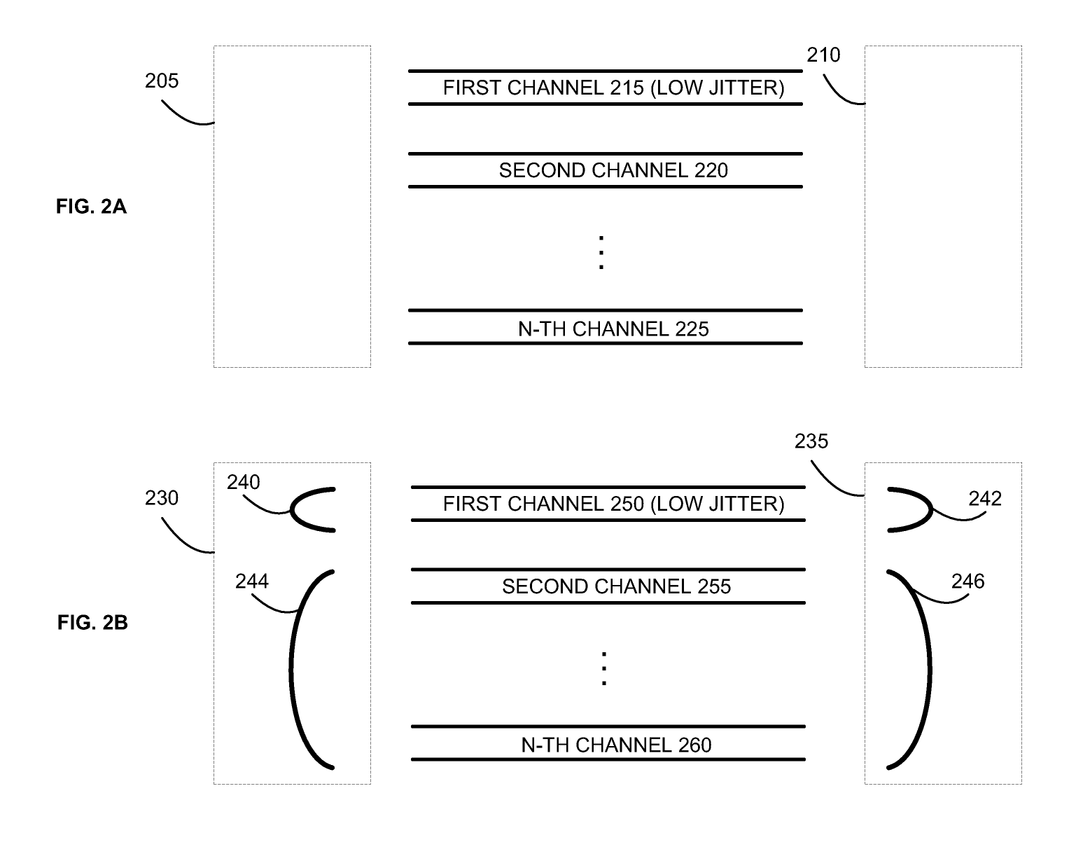

Reference is now made to FIG. 2A, which is a simplified illustration of a multi-channel communication system constructed and operating according to an embodiment.

FIG. 2A depicts a first node 205 having several communication channels to a second node 210. A first communication channel 215 is dedicated as a defined-jitter communication channel. Other communication channels, by way of a non-limiting example a second communication channel 220 and additional communication channels up to an N-th communication channel 225, may or may not be other defined-jitter communication channels.

The defined-jitter first communication channel 215 is a dedicated communication channel which is defined so as not to be affected by the problems causing jitter as exemplified above with reference to FIGS. 1C and 1D, that is, not to have variable queue lengths ahead of packets entering the first communication channel 215.

Optional features implemented for the defined-jitter first communication channel 215 include one or more of the following:

Optionally, the first communication channel 215 is set up so that any packet which gets transmitted through the first communication channel 215 is transmitted with a fixed delay, therefore the first communication channel 215 does not add any jitter at all to packet communication through the first communication channel 215.

Optionally, the first communication channel 215 is set up so that any first incoming packet gets transmitted through the first communication channel 215 within a fixed time.

Optionally, the first communication channel 215 is set up so that any first incoming packet gets transmitted through the first communication channel 215 after a fixed time.

Optionally, the first communication channel 215 is set up so that any first incoming packet gets transmitted through the first communication channel 215 before a second, next, incoming packet arrives. In some cases, this is not difficult to do. If it is known that one packet of a size of S bytes is to be transmitted through the first communication channel 215 every substantially fixed period of T seconds, and/or at a substantially fixed rate of transmission of every 1/T seconds, then the first communication channel 215 needs to have a capacity of substantially about S/T bytes/second (bps).

Optionally, the first communication channel 215 is set up so that most of the time an incoming packet gets transmitted through the first communication channel 215 before a next incoming packet arrives. In some cases, this is not difficult to do. If it is known that on the average one packet of a size of S bytes is to be transmitted through the first communication channel 215 every T seconds, with a certain variance around the average, then the first communication channel 215 needs to have a capacity bigger than about S/T bps. By having the bigger capacity, most of the time an incoming packet will get transmitted through the first communication channel 215 before a next incoming packet arrives.

How much bigger than S/T bps does the capacity need to be? That optionally depends on the variance and on what percentage of the time it is acceptable that an incoming packet gets delayed by another incoming packet still in the queue before it, which affects the jitter. Therefore how much bigger than S/T bps the capacity needs to be depends, at least in part, on what is an acceptable jitter. The variance and resultant jitter are optionally modeled by a statistical model, and a capacity of the channel is optionally set by results of running experiments using the statistical model.

In some embodiments, the first communication channel 215 is set up so that any incoming packet is no larger than a certain size, to prevent a first packet getting stuck behind a second, large, packet, as depicted in FIG. 1D.

As was described above, there is a relationship between a size S of packets which travel via the defined-jitter channel, a rate 1/T of the packets which travel via the defined-jitter channel, a bandwidth allocated for the defined-jitter channel, and the jitter which may be caused, amongst other reasons, by a queue of the packets before passing through the defined-jitter channel.

Controlling parameters such as the size, the rate, and the bandwidth, enables control of jitter. In some embodiments, controlling the jitter goes to minimizing jitter, and/or setting a maximum jitter level over a communication channel.

In some embodiments, the first communication channel 215 is set up so that any incoming packet is a certain type of packet, such as, by way of a non-limiting example, a synchronization packet. Optionally, a synchronization packet may be identified by the packet header.

In some embodiments, the first communication channel 215 is set up so that any incoming packet has a specific VLAN (Virtual LAN) ID, such as, by way of a non-limiting example, a VLAN for synchronization packets.

In some embodiments, the first communication channel 215 is set up so that any incoming packet has a specific UDP (User Datagram Protocol) port number.

In some embodiments, the first communication channel 215 is set up so that any incoming packet belongs to a specific Ether type.

The Bandwidth of the Defined-Jitter Channel

In some embodiments, given S and 1/T, a bandwidth is computed which causes substantially no jitter due to queuing for the defined-jitter channel.

Given a statistical variation of the rate 1/T, a bandwidth is computed which causes substantially no jitter due to queuing for the defined-jitter channel, and/or the bandwidth is computed which causes no more than some specific acceptable statistical jitter due to queuing.

Given a statistical variation of the size S, a bandwidth is computed which causes substantially no jitter due to queuing for the defined-jitter channel, and/or the bandwidth is computed which causes no more than some specific acceptable statistical jitter due to queuing. Given a statistical variation of both the rate 1/T and the size S, a bandwidth is computed which takes into account both statistical variations.

The bandwidth computed as described above is optionally the bandwidth of the defined-jitter channel, or a lower limit on the bandwidth of the defined-jitter channel.

Packet Size S

In some embodiments, given a specific bandwidth of the defined-jitter channel, and given the rate 1/T, a specific packet size limit is computed, such that if no packets over the size limit are transmitted via the defined-jitter channel, substantially no jitter is caused due to queuing for the defined jitterchannel.

Given a statistical variation of the rate 1/T, a size limit is computed which causes substantially no jitter due to queuing for the defined-jitter channel, and/or the size limit is computed which causes no more than some specific acceptable statistical jitter due to queuing. Packets transmitted via the defined-jitter channel are optionally limited to being less than the size limit.

The packet size computed as described above is optionally the packet size of the packets which are transferred through the defined-jitter channel, or an upper limit on the packet size of the packets which are transferred through the defined jitter channel.

Packet Transmission Rate 1/T

In some embodiments, given a specific bandwidth of the defined-jitter channel, and given the size S, a specific transmission rate limit is computed, such that if no packets over the transmission rate limit are transmitted via the defined-jitter channel, substantially no jitter is caused due to queuing for the defined-jitter channel.

In some embodiments, the transmission rate limit is optionally enforced over a source of the packets, especially in cases when providing the defined jitterchannel actually enables sending less packets. By way of a non-limiting example, when a time transfer protocol is more accurate, due to less jitter, the rate of transferring time transfer protocol packets may be lowered. The above is an example of where quality (low-jitter) rules over quantity (more synchronizing packets).

In some embodiments, the transmission rate limit is optionally enforced by not allowing some of the packets which belong in the defined-jitter channel to pass via the defined-jitter channel, if the transmission rate limit is exceeded by their passing. Such enforcement is proper when a function of the packets is better served by quality (low-jitter and/or no-jitter) than quantity (more packets via the defined-jitter channel). An example of such an implementation is for sync packets. Providing no-jitter sync packets enables improved synchronization, and well-synchronized communication nodes may be able to give up on frequent synchronization when synchronization is generally of such improved quality.

Given a statistical variation of the size S, a size limit is computed which causes substantially no jitter due to queuing for the defined-jitter channel, and/or the size limit is computed which causes no more than some specific acceptable statistical jitter due to queuing. Packets transmitted via the defined-jitter channel are optionally limited to being less than the size limit.

The transmission rate limit computed as described above is optionally the transmission rate limit of the packets which are transferred through the defined-jitter channel, or an upper limit on the transmission rate limit of the packets which are transferred through the defined-jitter channel.

How do exemplary embodiments implement a defined-jitter communication channel? Some exemplary embodiments and their implementations of the defined-jitter communication channel are described below.

Reference is now made to FIG. 2B, which is a simplified illustration of an alternative embodiment of the system of FIG. 2A.

FIG. 2B depicts a first node 230 having several communication channels to a second node 235. A first communication channel 215 is dedicated as a defined-jitter communication channel. The first communication channel 215 is transmitted by a first transmitter 240 in the first node 230 to a first receiver 242 in the second node 235.

Other communication channels, by way of a non-limiting example a second communication channel 255 and additional communication channels up to an N-th communication channel 260, are optionally transmitted by a second transmitter 244 in the first node 230 to a second receiver 246 in the second node 235.

In the embodiment of FIG. 2B, the defined-jitter communication channel is implemented by a dedicated transmitter-receiver pair, or if not a dedicated transmitter-receiver pair, then at least a transmitter-receiver pair which can provide at least some of the defined-jitter options described with reference to FIG. 2A.

Some embodiments do not necessarily use such a transmitter-receiver pair.

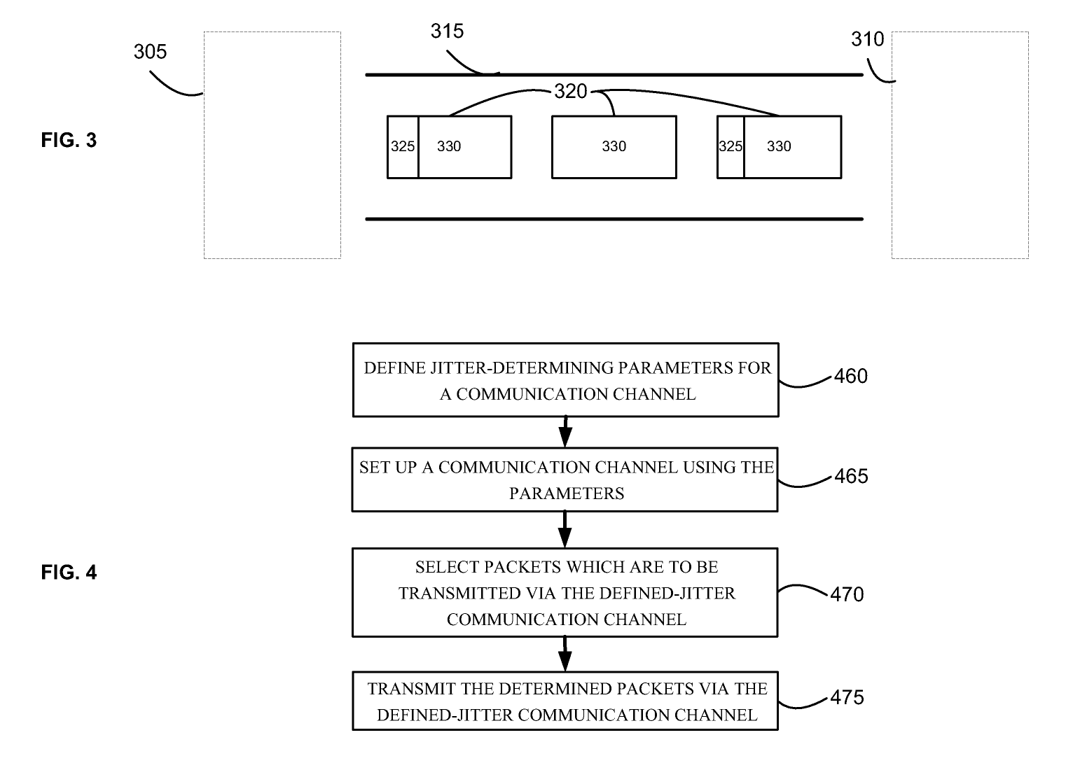

Reference is now made to FIG. 3, which is a simplified illustration of an alternative embodiment of the system of FIG. 2A.

FIG. 3 depicts a first node 305 having a main communication channel 315 to a second node 310. The main communication channel 315 is divided into sub-channels, one of which is a defined-jitter communication sub-channel.

Data sent through the main communication channel 315 is packaged in frames 320. The data is packaged into the frames in a fashion which implements virtual sub-channels over the main communication channel 315.

By way of a non-limiting example, FIG. 3 depicts how one defined-jitter sub-channel and one other sub-channel are implemented over the main communication channel 315.

Some of the frames 320 are divided into a first section 325 for data of the defined-jitter sub-channel and a second section 330 for data of the other sub-channel.

In order for the defined-jitter sub-channel to provide defined-jitter communications, one or more of the following optional features are implemented:

Optionally, the defined-jitter sub-channel is set up so that any incoming packet destined for the defined-jitter sub-channel gets transmitted through the main communication channel 315 after a fixed queuing time.

Optionally, the defined-jitter sub-channel is set up so that any incoming packet destined for the defined-jitter sub-channel gets transmitted through the main communication channel 315 after less than a fixed queuing time.

Optionally, the defined-jitter sub-channel is set up so that any incoming packet destined for the defined-jitter sub-channel gets transmitted through the very next frame 320 to be sent through the main communication channel 315.

Optionally every one of the frames 320 includes an instance of the first section 325, so that delay time of packets sent via the first section 325 are always exactly a duration of one frame.

Optionally the size of the first section 325 is enough to contain all packets expected to arrive for the defined jittersub-channel during a time required for transmitting a frame.

Implementing the transmission within a fixed time does not necessarily mean that the transmission occurs in the next frame 320. A fixed queuing time of one or more frames may be set up, still providing a defined-jitter sub-channel, with a substantially fixed time for transmission. Even though the time of transmission is not a lowest time possible, it is substantially fixed, and therefore low jitter.

Optionally the defined-jitter sub-channel is set up so that most of the time an incoming packet for the defined-jitter packet gets transmitted in a first section 325 through the main communication channel 315 before a next incoming packet for the defined-jitter sub-channel arrives. Given an average one packet of a size of S bytes to be transmitted through the main communication channel 315 every T seconds, with a certain variance around the average, and that frames 320 are sent at a rate of F frames per second, then the size of the first section 325 optionally has a capacity bigger than about S/ (T*F) bytes. By using the bigger capacity, most of the time an incoming packet will get transmitted in the first section 325 through the main communication channel 315 before a next incoming packet for the defined-jitter sub-channel arrives.

How much bigger than S/ (T*F) bytes does the capacity of the first section 325 need to be? That optionally depends on the variance and on what percentage of the time it is acceptable that an incoming packet gets delayed by another incoming packet still in the queue before it, and/or gets packaged together with another packet within the same first section 325, both of which affect the jitter. It is noted that in instances when two packets are occasionally packaged in a same first section 325, the jitter may increase relative to instances when only one packet is packaged in a first section 325.

The capacity of the first section 325 depends, at least in part, on what is an acceptable jitter. The variance and resultant jitter are optionally modeled by a statistical model, and a capacity of the channel is optionally set by results of running experiments using the statistical model.

Optionally, the defined-jitter communication channel is set up so that any incoming packet is no larger than a certain size, to prevent an incoming packet from being larger than the first section 325.

In cases where the rate of frames 320 sent over the main communication channel 315 F exceeds the rate of packets which are to be sent over the defined jitter sub-channel, which is 1/T, two options are provided.

In a first option, in some embodiments, frames 320 which do not carry a packet for the defined-jitter sub-channel are still divided into a first section 325, which is in such an instance empty.

In a second option, in some embodiments, frames 320 which do not carry a packet for the defined-jitter sub-channel are not divided into the first section 325 and the second section 330. The frame effectively contains only the second section 330.

It is noted that more than one defined-jitter sub-channel may be included in the main communication channel 315, and including more than one is performed by adding sections for the additional defined-jitter sub-channels.

It is noted that the dedicated communication channel does not have to provide a lowest queuing time, or a lowest transmission time. The dedicated communication channel optionally provides a substantially fixed queuing time. The dedicated communication channel optionally also provides a substantially fixed transmission time. Jitter is caused by variations in queuing times and transmission times, and an embodiment lowers jitter.

It is noted that while the term network is used herein for many examples, the dedicated communication channel optionally decreases jitter from source of the communication channel to destination of the communication channel. The communication channel may be a point-to-point communication system, and even a one-way (not duplex) communication system, and the present invention still applies. The present invention is taught without limitation on understanding the term network, and applies to communication systems.

A non-limiting example of the communication channel of the present invention is a point-to-point radio communication link.

Some embodiments include at least a portion of a packet switching network, over which network traffic may be separated into one or more defined-jitter communication channels, and one or more “other” communication channels.

By “at least a portion” it is meant that even if only a point-to-point leg of a packet network provides a defined jitter channel, traffic along the point-to-point leg can benefit from using the defined jitter channels. Traffic which uses the defined jitter channel as only one leg of a longer journey can also reduce jitter by using the lower jitter channel on that leg.

If a section of a packet network, larger than a point-to-point leg, implements the present embodiments for defined-jitter channels in the section, traffic going through the section can also reduce jitter by using the defined jitterchannels.

Passing packet switched traffic over a defined-jitter portion of a packet switching network may lower overall jitter for the traffic which may start and/or end outside the defined jitterportion, yet pass through the portion.

A point-to-point communication provider which provides a defined-jitter option for at least some of the packet switched traffic passing over the point-to-point communication link is providing a better point-to-point communication service, for at least some of the packet switched traffic.

Some embodiments are applicable in a packet switching protocol which is implemented over a circuit switching network.

Reference is now made to FIG. 4, which is a simplified flowchart illustration of an embodiment.

The embodiment of FIG. 4 is implemented in a first packet-switched communication system.

Parameters which affect a maximum jitter level in a communication channel, such as, for example, the parameters described above with reference to FIG. 2A: packet size, packet rate of transmission, and bandwidth, are defined (460).

A communication channel for carrying at least some of the packets of the packet-switched communication system is set up using the parameters (465).

Packets from the first packet-switched communication system, which are to be transmitted via the defined-jitter communication channel, are selected (470).

The packets which have been determined to be transmitted via the defined-jitter communication channel are transmitted via the defined-jitter communication channel (475).

In some embodiments, the defined-jitter communication channel is optionally set up having a bandwidth based, at least in part, on a size of the determined packets and on a rate of transmission of the determined packets, as described above in more detail with reference to FIG. 2A.

In some embodiments, the determination of which packets are to be transmitted via the defined-jitter communication channel is optionally made by keeping the determined packets under a certain size.

In some embodiments, the determination of which packets are to be transmitted via the defined-jitter communication channel is optionally made by selecting synchronization packets and/or time transfer protocol packets.

In some embodiments, the determination of which packets are to be transmitted via the defined jittercommunication channel is optionally made by including packets according to the IEEE 1588 time-transfer protocol.

In some embodiments, the defined-jitter communication channel is implemented over the first packet-switched communication system.

In some embodiments, the defined-jitter communication channel is implemented over a second communication system.

In some embodiments, the defined jittercommunication channel is a fixed delay communication channel.

The determined packets enjoy less variance in packet size, which, as was explained with reference to the problem described with reference to FIG. 1D, produces less jitter over the second packet-switched communication channel.

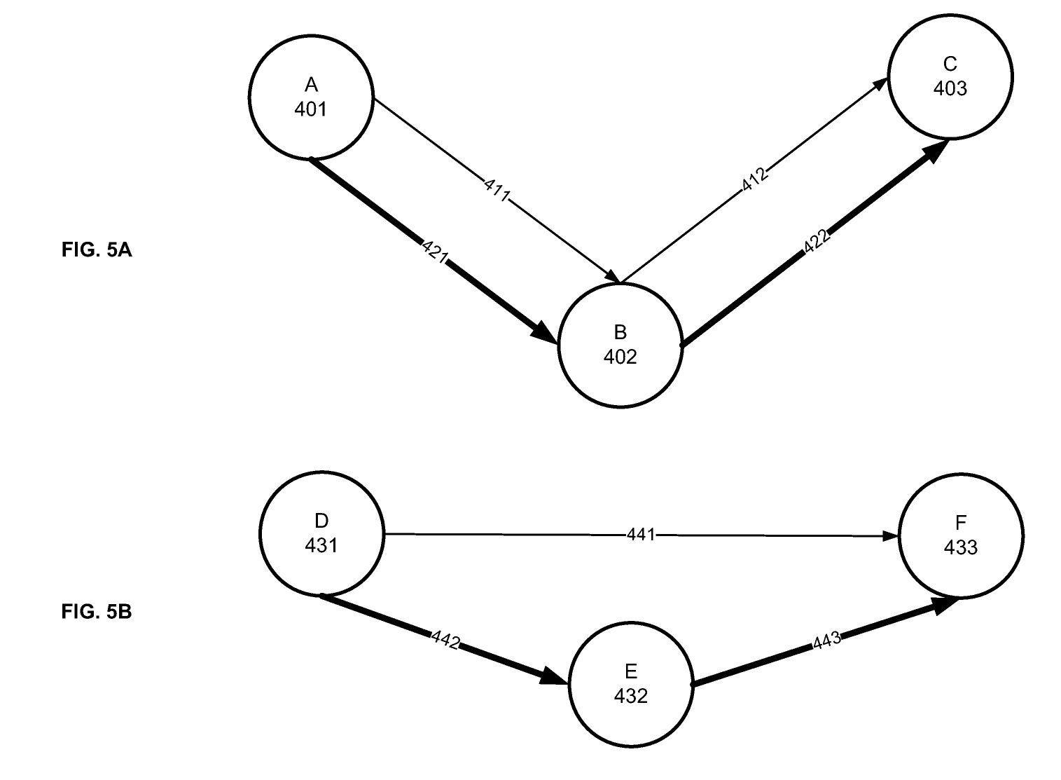

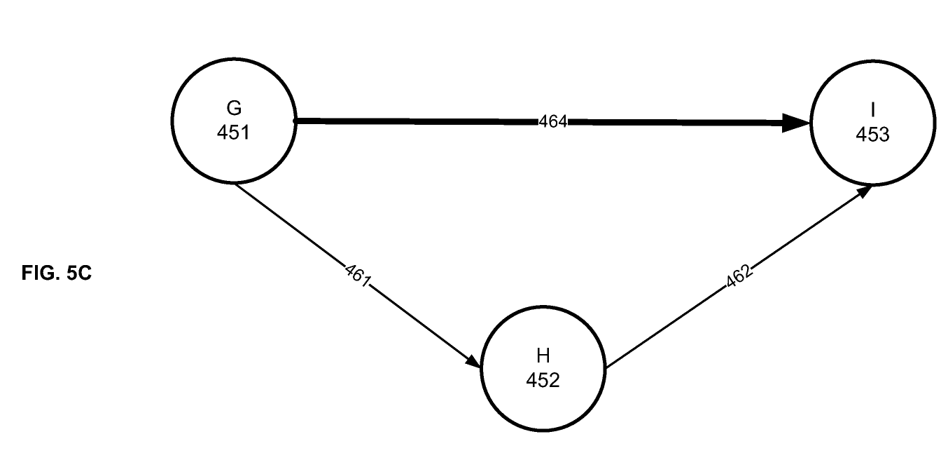

Reference is now made to FIG. 5A, which is a simplified illustration of an embodiment of the system of FIG. 2A which includes more than two nodes.

FIGS. 2A, 2B and 3 depicted a defined jitter channel implemented between two communication nodes. An example embodiment is now provided, including three nodes: node A 401, node B 402, and node C 403. It is emphasized that the example embodiment of three nodes is expandable to more nodes as needed.

A first defined-jitter sub-channel 411 is established between node A 401 and node B 402, and a second defined-jitter sub-channel 412 is established between node B 401 and node C 403. Node B 402 receives data passed along the first defined jitter sub-channel 411, and optionally sends the data along the second defined-jitter sub-channel 412 to node C 403. The data has been transferred along two defined-jitter sub-channel sections, and passing through two defined-jitter sub-channel sections provides an effect of passing through a defined jittersub-channel from node A 401 to node C 403.

FIG. 5A depicts other, not necessarily defined jittersub-channels 421 from node A 401 to node B 402, and other, not necessarily defined-jitter sub-channels 422 from node B 402 to node C 403, to illustrate that the defined-jitter sub-channels 411 412 optionally exists in parallel with non defined-jitter sub-channels 421 422.

Reference is now made to FIG. 5B, which is a simplified illustration of an alternative embodiment of the system of FIG. 2A which includes more than two nodes.

FIG. 5B depicts three nodes: node D 431, node E 432, and node F 433. A defined-jitter sub-channel 441 is established between node D 431 and node F 433. Other, not necessarily defined-jitter sub-channels 442 from node D 431 to node E 432, and other, not necessarily defined-jitter sub-channels 443 from node E 432 to node F 433, to illustrate that the defined jittersub-channel 441 optionally exists over a different path, yet connecting the same nodes, as non defined-jitter sub-channels 442 443.

Reference is now made to FIG. 5C, which is a simplified illustration of another alternative embodiment of the system of FIG. 2A which includes more than two nodes.

FIG. 5C depicts three nodes: node G 451, node H 452, and node I 453.

A first defined-jitter sub-channel 461 is established between node G 451 and node H 452, and a second defined-jitter sub-channel 462 is established between node H 452 and node I 453. Node H 452 receives data passed along the first defined-jitter sub-channel 461, and optionally sends the data along the second defined-jitter sub-channel 462 to node I 453. The data has been transferred along two defined-jitter sub-channel sections, and passing through two defined-jitter sub-channel sections provides an effect of passing through a defined-jitter sub-channel from node G 451 to node I 453.

FIG. 5C depicts other, not necessarily defined-jitter sub-channels 464 from node G 451, optionally at least some of the sub-channels 464 directly to node I 453, to illustrate that the defined-jitter sub-channels 461 462 optionally exist over a different path, yet connecting the same nodes, as non defined-jitter sub-channels 464.

Example Applications

An Improved Time Transfer Protocol

An example jitter-sensitive application which is presently being sent over IP networks is IEEE time-transfer protocol 1588 (termed herein 1588), which seeks to achieve sub-microsecond accuracy in timing synchronization between network nodes. As described in the Background section above, wide variations in network traffic may negatively impact clock skew as the delay correction lags current traffic conditions, and 1588 synchronization accuracy may be negatively impacted by jitter.

Some embodiments transfer 1588 time-transfer packets via a dedicated low-jitter communication channel.

As mentioned in the Background, the IEEE 1588 PTP recognizes the existence of jitter, and provides an arithmetical method to decrease the adverse effect of jitter on synchronization across networks. Embodiments provide a way to lower the jitter, thereby improving synchronization.

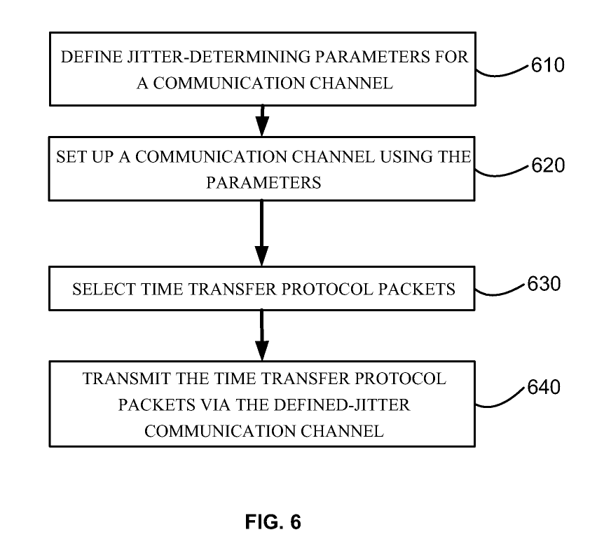

Reference is now made to FIG. 6, which is a simplified flowchart illustration of an example embodiment applied to a time transfer protocol.

The embodiment of FIG. 6 is implemented in a first packet-switched communication system.

Some packets of first packet-switched communication channel optionally include time transfer protocol packets, which are destined to be transmitted via a low-jitter channel.

Parameters which affect a maximum jitter level in a communication channel, such as, for example, the parameters described above with reference to FIG. 2A: packet size, packet rate of transmission, and bandwidth, are defined (610).

A defined-jitter communication channel is set up in the first packet-switched communication system (620). In some embodiments the defined jitter is low jitter, minimal jitter, and/or zero jitter.

Time transfer protocol packets are selected for transmission via the defined-jitter communication channel (630), and the time transfer protocol packets are transmitted via the defined-jitter communication channel (640).

As stated above with reference to FIG. 4, the defined-jitter communication channel may be set up over the same first packet-switched communication system, or over a different communication system.

### Synchronizing Cellular Base Stations Over a Packet Network

An example application of a defined, low-jitter, channel is found in the field of cellular communications.

It is a paradox that cellular communications, using a protocol such as Time Division Multiplexing (TDM), carry synchronization information from Base Stations (BSs) to Mobile Stations (MSs) with one degree of accuracy, while the BSs of each cell may be using a network with a second degree of accuracy, which is lower than the first degree of accuracy, for synchronizing with each other.

Cellular communication BSs need to be synchronized in order for hand-off of a MS to take place from one BS to another. Connecting the BSs by a packet network such as an Ethernet can be a useful and inexpensive solution, if synchronization signals carried through the Ethernet provide accurate enough synchronization.

Some embodiments optionally transfer 1588 time-transfer packets over Ethernet, between BSs, via a dedicated low jittercommunication channel.

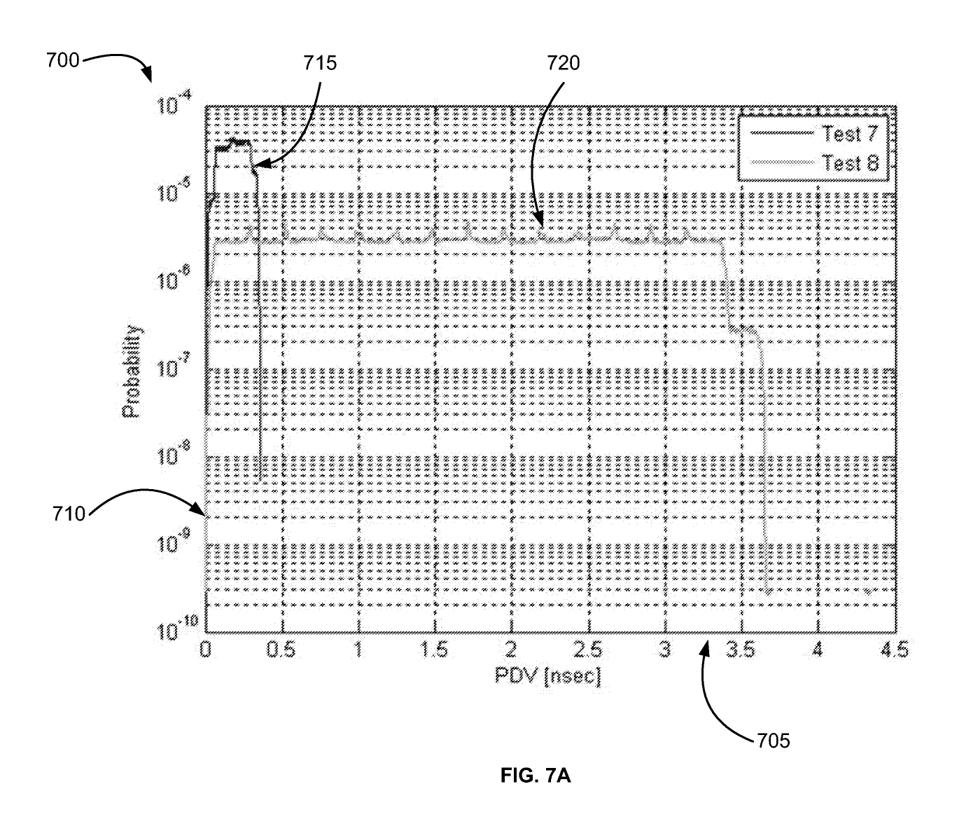

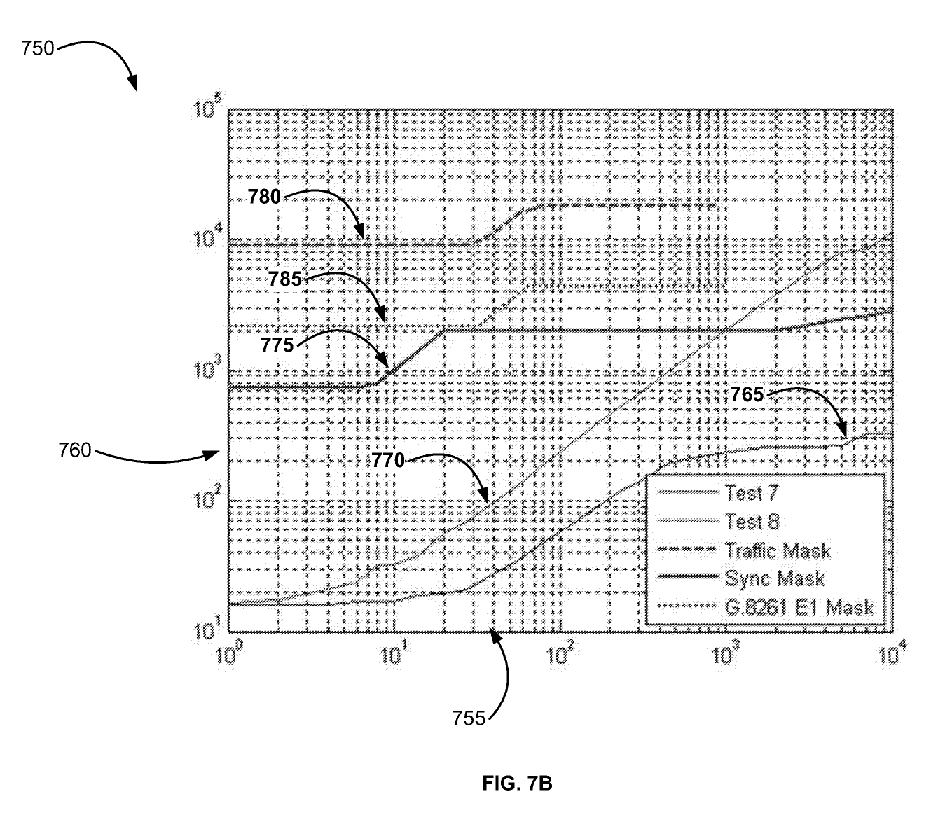

Reference is now made to FIG. 7A, which is a histogram 700 of Packet Delay Variation (PDV) of two simulations, made with and without using an example embodiment.

It is noted that PDV is a measure of jitter.

The histogram 700 includes an x-axis 705 depicting PDV, and a y-axis 710 depicting probability.

A first trace 715 depicts a result of a first simulation, made, by way of a non-limiting example, by sending synchronization packets at a rate of 64 synchronization packets per second, via a defined-jitter channel according to an example embodiment. Typical background data was also sent, at a load of 90% of the available bandwidth.

A second trace 720 depicts a result of a second simulation, made, by way of a non-limiting example, by sending synchronization packets at a rate of 64 synchronization packets per second, without using the defined-jitter channel. Typical background data was also sent, at a load of 90% of the available bandwidth.

The second trace 720 shows that under conditions of the simulation there was a PDV of up to about 3.5 nSec, at a more or less similar probability level.

The first trace 715 shows that under conditions of the simulation, using an example embodiment, there was a PDV of no more than about 0.35 nSec.

Jitter and wander are defined respectively as “the short-term and the long-term variations of the significant instants of a digital signal from their ideal positions in time”.

The two simulations of FIG. 7A were performed and a measure of wander, termed MTIE (Maximum Time Interval Error) is shown for the two simulations. MTIE is a measure of the worst case phase variation of a signal with respect to a perfect signal over a given period of time.

Reference is now made to FIG. 7B, which is a graph 750 of a Maximum Time Interval Error (MTIE) for two simulations similar to the simulations of FIG. 7A, compared to several communication quality limits.

The graph 750 includes an x-axis 755 depicting a period, or window, of time, in seconds, during which the MTIE was measured, and a y-axis 760 depicting a size of the MTIE in microseconds.

A first trace 765 depicts a result of a first simulation, made under the same communication channel conditions as described with reference to FIG. 7A.

A second trace 770 depicts a result of a second simulation, made under the same conditions as described with reference to FIG. 7A.

A third trace 775 depicts an MTIE mask, or communication quality limit, allowed for synchronization packets under IEEE 1588 (PTP).

A fourth trace 780 depicts an MTIE mask, allowed for typical traffic packets.

A fourth trace 785 depicts an MTIE mask, allowed for G.2861 E1 communications. G.8261 describes synchronization methods in packet networks. G.8261 includes both Synchronized Ethernet and packet based synchronization such as described in IEEE 1588.

The second trace 770 shows that under some conditions of the simulation, not using an embodiment to lower jitter and wander, the MTIE may exceed the communication quality limit allowed for synchronization packets.

The first trace 765 shows that under all conditions of the simulation, using an example embodiment, the MTIE is substantially lower than not using the example embodiment.

It is expected that during the life of a patent maturing from this application many relevant time transfer protocols, QoS protocols, and packet switching networks will be developed and the scope of the terms “time transfer protocol”, “QoS protocol”, and “packet switching network” are intended to include all such new technologies a priori.

As used herein the term “about” refers to ±10%.

The terms “comprising”, “including”, “having” and their conjugates mean “including but not limited to”.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as “an example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for decreasing jitter for at least some packets in a first packet-switched communication system comprising:
defining parameters for a communication channel wherein said parameters determine a maximum jitter level;
setting up a communication channel using said parameters to provide a channel with a predefined maximum jitter level;
selecting packets from the first packet-switched communication system which are to be transmitted via the defined-jitter communication channel; and
transmitting the determined packets via the defined-jitter communication channel.

2. The method of claim 1, in which said parameters comprise at least one member of the group comprising a bandwidth, a maximum packet size and a transmission rate.

3. The method of claim 2, in which a specific bandwidth is defined for the defined-jitter channel, based, at least in part, on a size of the determined packets and a required rate of transmission of the determined packets.

4. The method of claim 2, in which a specific packet size limit is defined for the defined jitterchannel, based, at least in part, on a required rate of transmission of the determined packets and on bandwidth allotted to the defined-jitter communication channel.

5. The method of claim 2, in which a limit on a rate of transmission of the determine packets is set, based, at least in part, on a size of the determined packets and on bandwidth allocated to the defined jittercommunication channel.

6. The method of claim 1 in which the determining comprises selecting packets under a certain size.

7. The method of claim 1 in which the determining comprises selecting synchronization packets.

8. The method of claim 1 in which the determining comprises selecting packets operational according to the IEEE 1588 time-transfer protocol.

9. The method of claim 1 in which the defined jitter communication channel is implemented over the first packet-switched communication system.

10. The method of claim 1 in which the defined jitter communication channel is implemented over a second communication system.

11. The method of claim 1 and further comprising:
packaging the packets of the packet-switched communication channel in frames; and
packaging the determined packets in a dedicated portion of at least some of the frames.

12. The method of claim 1 in which the packet-switched communication channel comprises a fixed delay communication channel.

13. A transmitter using the method of claim 1.

14. A receiver using the method of claim 1.

15. A communication system using the method of claim 1.

16. A computer-readable storage medium containing a set of instructions for implementing the method of claim 1.

17. A packet switched network operating a designated defined-jitter channel for packets requiring defined jitter.

18. The network of claim 17, in which the defined-jitter channel comprises a specified bandwidth, based, at least in part, on a size of the packets requiring defined jitter and on a rate of transmission of the packets requiring defined jitter.

19. The network of claim 17 in which the packets requiring defined jitter comprise synchronization packets.

20. The network of claim 17 in which the packets requiring defined jitter comprise packets according to the IEEE 1588 time-transfer protocol.

21. The network of claim 17 in which the defined-jitter channel comprises a fixed delay channel.
